(19) United States
(12) Patent Application Publication
(10) Pub. No.: US 2014/0133657 A1
(43) Pub. Date: May 15, 2014

(54) MOBILE ELECTRONIC DEVICE AND AUDIO PLAYING MEANS THEREOF

(71) Applicant: NVIDIA Corporation, Santa Clara, CA (US)

(72) Inventor: Shuang Xu, Shenzhen (CN)

(21) Appl. No.: 13/911,009

(22) Filed: Jun. 5, 2013

(30) Foreign Application Priority Data
Nov. 9, 2012 (CN) 201210448439.1

(51) Int. Cl. H04R 5/04

(52) U.S. Cl. CPC H04R 5/04
USPC 381/1

(57) ABSTRACT

The present invention provides a mobile electronic device and an audio playing means thereof. The audio playing means comprises a first audio player and a second audio player for playing a left channel audio and a right channel audio respectively; a first audio receiver and a second audio receiver for receiving a first echo of the left channel audio and a second echo of the right channel audio in real time respectively; and a control unit for compensating the left channel audio and the right channel audio according to the first echo and the second echo which are received, and controlling the first audio player and the second audio player to play a compensated left channel audio and a compensated right channel audio respectively, wherein the compensated left channel audio and the compensated right channel audio are able to offset the first echo and the second echo respectively. The audio playing means provided by the present invention compensates the left channel audio and the right channel audio by receiving the echoes generated by the left channel audio and the right channel audio. Therefore, the asymmetry between the left channel audio and the right channel audio is eliminated so that the listener experiences the good stereo effect.

### CROSS-REFERENCE TO RELATED APPLICATIONS

This application claims priority to Chinese Patent Application No. 201210448439.1, filed on Nov. 9, 2012, which is hereby incorporated by reference in its entirety.

### FIELD OF INVENTION

The present invention relates generally to the electrics field, in particular, to a mobile electronic device and an audio playing means thereof.

### BACKGROUND

The mobile electronic device (such as a tablet, a mobile phone etc.) is used as an audio playing means widely. Moreover, the listener desires that the audio played by the mobile electronic device has stereo effect. By utilizing a pair of audio player to play the left channel audio corresponding to the left ear and the right channel audio corresponding to the right ear respectively, the listener can experience the stereo effect.

But the use environment of the mobile electronic device is usually complex, and moreover, the listener even listens to the audio while moving, thus it leads to significant asymmetry of the echoes generated by the left channel audio and the right channel audio. The asymmetric echoes lead to the imbalance between the left channel audio and the right channel audio, and further lead to the fuzziness of the stereo effect.

Therefore, there is a need of providing a mobile electronic device and an audio playing means thereof to solve the above problem in the prior art.

### SUMMARY OF THE INVENTION

In order to solve the above problem, an audio playing means of a mobile electronic device is provided according to one aspect of the present invention. The audio playing means of a mobile electronic device comprises a first audio player and a second audio player for playing a left channel audio and a right channel audio respectively; a first audio receiver and a second audio receiver for receiving a first echo of the left channel audio and a second echo of the right channel audio in real time respectively; and a control unit for compensating the left channel audio and the right channel audio according to the first echo and the second echo which are received, and controlling the first audio player and the second audio player to play a compensated left channel audio and a compensated right channel audio respectively, wherein the compensated left channel audio and the compensated right channel audio are able to offset the first echo and the second echo respectively.

Preferably, the control unit comprises a first filter and a second filter, the first filter takes an audio signal with the same frequency as the left channel audio and a smaller amplitude than the left channel audio as the first echo, the second filter takes an audio signal with the same frequency as the right channel audio and a smaller amplitude than the right channel audio as the second echo.

Preferably, the control unit comprises a first inverter, a first synthesizer, a second inverter and a second synthesizer, the first inverter receives the first echo and generates a first antiphase signal of the first echo, the first synthesizer synthesizes the first antiphase signal and the left channel audio into the compensated left channel audio, the second inverter receives the second echo and generates a second antiphase signal of the second echo, and the second synthesizer synthesizes the second antiphase signal and the right channel audio into the compensated right channel audio.

Preferably, the control unit further comprises an amplifier for amplifying the first echo and the second echo before the first echo and the second echo are received by the first inverter and the second inverter.

Preferably, the control unit further comprises a phase adjusting means for adjusting phases of the first echo and the second echo output by the amplifier.

Preferably, the first inverter comprises a first A/D converter, a first digital signal processor and a first D/A converter, the first A/D converter is used for converting the first echo into a digital signal, the first digital signal processor is used for generating an antiphase signal of the first echo converted into the digital signal, and the first D/A converter is used for converting the antiphase signal in the form of the digital signal into an analogue signal to generate the first antiphase signal.

Preferably, the second inverter comprises a second A/D converter, a second digital signal processor and a second D/A converter, the second A/D converter is used for converting the second echo into a digital signal, the second digital signal processor is used for generating an antiphase signal of the second echo converted into the digital signal, and the second D/A converter is used for converting the antiphase signal in the form of the digital signal into an analog signal to generate the second antiphase signal.

Preferably, the control unit further comprises a first post filter and a second post filter, the first post filter is used for smoothing the first antiphase signal output by the first inverter and sending it to the first synthesizer, and the second post filter is used for smoothing the second antiphase signal output by the second inverter and sending it to the second synthesizer.

Preferably, the first audio receiver and the second audio receiver also receive a noise with a fixed frequency, and the control unit compensates the left channel audio and the right channel audio according to the noise.

Preferably, the first audio receiver and the second audio receiver are microphones.

A mobile electronic device is further provided according to another aspect of the present invention. The mobile electronic comprises an audio playing means and the audio playing means includes a first audio player and a second audio player disposed at the mobile electronic device symmetrically for playing a left channel audio and a right channel audio respectively; a first audio receiver and a second audio receiver disposed at the mobile electronic device symmetrically for receiving a first echo of the left channel audio and a second echo of the right channel audio in real time respectively; and a control unit for compensating the left channel audio and the right channel audio according to the first echo and the second echo which are received, and controlling the first audio player and the second audio player to play a compensated left channel audio and a compensated right channel audio respectively, wherein the compensated left channel audio and the compensated right channel audio are able to offset the first echo and the second echo respectively.

Preferably, the control unit comprises a first filter and a second filter, the first filter takes an audio signal with the same frequency as the left channel audio and a smaller amplitude than the left channel audio as the first echo, and the second filter takes an audio signal with the same frequency as the right channel audio and a smaller amplitude than the right channel audio as the second echo.

Preferably, the control unit comprises a first inverter, a first synthesizer, a second inverter and a second synthesizer, the first inverter receives the first echo and generates a first antiphase signal of the first echo, the first synthesizer synthesizes the first antiphase signal and the left channel audio into the compensated left channel audio, the second inverter receives the second echo and generates a second antiphase signal of the second echo, and the second synthesizer synthesizes the second antiphase signal and the right channel audio into the compensated right channel audio.

Preferably, the control unit further comprises an amplifier for amplifying the first echo and the second echo before the first echo and the second echo are received by the first inverter and the second inverter.

Preferably, the control unit further comprises a phase adjusting means for adjusting phases of the first echo and the second echo output by the amplifier.

Preferably, the first inverter comprises a first A/D converter, a first digital signal processor and a first D/A converter, the first A/D converter is used for converting the first echo into a digital signal, the first digital signal processor is used for generating an antiphase signal of the first echo converted into the digital signal, and the first D/A converter is used for converting the antiphase signal in the form of the digital signal into an analog signal to generate the first antiphase signal.

Preferably, the second inverter comprises a second A/D converter, a second digital signal processor and a second D/A converter, the second A/D converter is used for converting the second echo into a digital signal, the second digital signal processor is used for generating an antiphase signal of the second echo converted into the digital signal, and the second D/A converter is used for converting the antiphase signal in the form of the digital signal into an analog signal to generate the second antiphase signal.

Preferably, the control unit further comprises a first post filter and a second post filter, the first post filter is used for smoothing the first antiphase signal output by the first inverter and sending it to the first synthesizer, and the second post filter is used for smoothing the second antiphase signal output by the second inverter and sending it to the second synthesizer.

Preferably, the first audio receiver and the second audio receiver further receive a noise with a fixed frequency, and the control unit compensates the left channel audio and the right channel audio according to the noise.

Preferably, the first audio player and the second audio player are disposed symmetrically at a top and a bottom of the mobile electronic device respectively, and the first audio receiver and the second audio receiver are disposed symmetrically at the top and the bottom of the mobile electronic device.

The audio playing means provided by the present invention compensates the left channel audio and the right channel audio by receiving the echoes generated by the left channel audio and the right channel audio to generate the compensated audio signals which are able to offset the echoes. Therefore, the asymmetry between the left channel audio and the right channel audio is eliminated so that the listener experiences the good stereo effect.

A serial of simplified conceptions are incorporated into the summary of the invention, which will be further described in more detail in the detailed description. The summary of the invention neither implies that it is intended to limit the essential features and necessary technical features of the technical solution to be protected, nor implies that it is intended to define the protection scope of the technical solution to be protected.

Advantages and features of the present invention will be described in detail below in connection with the accompanying drawings.

### BRIEF DESCRIPTION OF THE DRAWINGS

The following drawings of the present invention as a part of the present invention herein are used for understanding of the present invention, the embodiments and the descriptions thereof are illustrated in the drawings for explaining the principle of the present invention. In the drawings,

FIG. 1 is a schematic view of a mobile electronic device according to one embodiment of the invention;

FIG. 2 is a schematic block diagram of an audio playing means according to one embodiment of the invention;

FIG. 3 is a schematic block diagram of an audio playing means according to one preferred embodiment of the invention;

FIG. 4 is a schematic block diagram of an audio playing means according to yet another preferred embodiment of the invention; and

FIG. 5 is a schematic block diagram of an audio playing means according to still another preferred embodiment of the invention.

### DETAILED DESCRIPTION

A plenty of specific details are presented so as to provide more thoroughly understanding of the present invention in the description below. However, the present invention may be implemented without one or more of these details, as is obvious to those skilled in the art. In other examples, some of the technical features known in the art are not described so as to avoid confusions with the present invention.

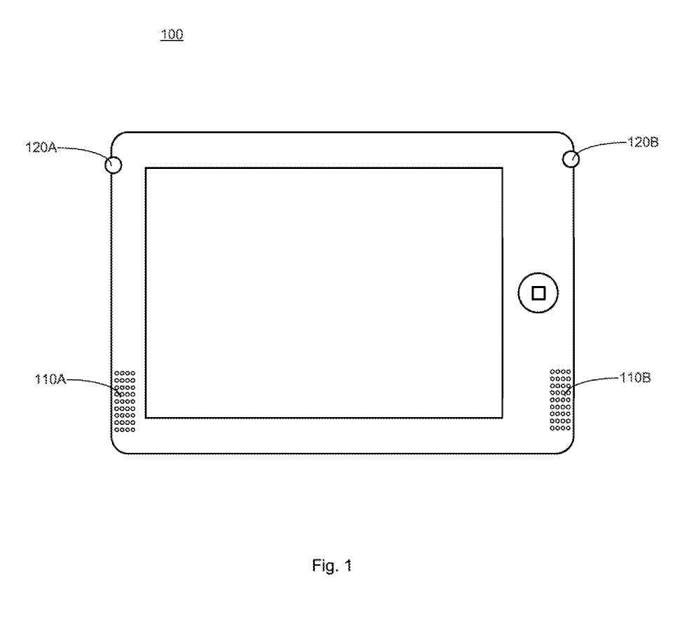

According to one aspect of the present invention, an audio playing means of a mobile electronic device (hereinafter referred to as the audio playing means) is provided. In order to generally understand the audio playing means, the mobile electronic device is described in combination with FIG. 1 firstly. As shown in FIG. 1, the mobile electronic device 100 comprises a first audio player 110A, a second audio player 110B, a first audio receiver 120A, a second audio receiver 120B and a control unit (not shown).

The first audio player 110A and the second audio player 110B are disposed symmetrically at the mobile electronic device 110 for playing a left channel audio and a right channel audio respectively. The first audio player 110A and the second audio player 110B play the left channel audio and the right channel audio simultaneously so that the listener can experience a two-channel stereo audio. The first audio player 110A and the second audio player 110B may be any means which is able to play the audio, such as a speaker, etc. In general, the first audio player 110A and the second audio player 110B are disposed in the housing of the mobile electronic device 100.

Likewise, the first audio receiver 120A and the second audio receiver 120B are disposed symmetrically at the mobile electronic device 110 for receiving an echo of the left channel audio (hereinafter referred to as a first echo) and an echo of the right channel audio (hereinafter referred to as a second echo) in real time and converting the sound signals into electric signals or other forms of signals. The left channel audio and the right channel audio are both transferred outward in the form of sound waves. The sound waves encounter obstacles and are reflected during the transfer process. At the same time a part of energy is absorbed by the obstacles so that the frequency of the first echo of the left channel audio and the frequency of the second echo of the right channel audio basically remain unchanged, but the amplitude of the first echo of the left channel audio and the amplitude of the second echo of the right channel audio decay significantly compared with the original left channel audio and the original right channel audio. The decaying-degrees of the amplitudes are related to the transfer distances as well as the shapes and the materials of the obstacles encountered during the transfer process.

As an example, the first audio receiver 120A and the second audio receiver 120B can be microphones. The microphone which is used as an energy converting appliance for converting the sound signal into the electric signal is mainly a standard feature in the existing mobile electronic device. Therefore, the cost can be reduced by taking the standard features of the existing mobile electronic device as a part of the audio playing means provided by the present invention. The designer just considers disposing the first audio receiver 120A and the second audio receiver 120B at the mobile electronic device 100 symmetrically. The first audio receiver 120A and the second audio receiver 120B may be one or more of an electrodynamics microphone, a capacitive microphone, a piezoelectric microphone, an electromagnetic microphone and a semiconductor microphone.

The relative positions of the first audio player 110A, the second audio player 110B, the first audio receiver 120A and the second audio receiver 1208 on the mobile electronic device 100 shown in FIG. 1 is only exemplary, therefore, it should not be understood to limit the present invention.

Preferably, the first audio player 110A and the second audio player 110B are disposed symmetrically at the top and the bottom of the mobile electronic device 100 respectively, and the first audio receiver 120A and the second audio receiver 120B are disposed symmetrically at the top and the bottom of the mobile electronic device 100 respectively. Usually, the mobile electronic device 100 plays the audio together with the corresponding video. Therefore, the user puts the mobile electronic device 100 as shown in FIG. 1 when the mobile electronic device 100 is used to play the audio. In this case, the first audio player 110A, the second audio player 110B, the first audio receiver 120A and the second audio receiver 120B are disposed in the preferred manner mentioned above so that the listener can experience the good stereo effect.

The control unit compensates the left channel audio played by the first audio player 110A and the right channel audio played by the second audio player 110B according to the first echo received by the first audio receiver 120A and the second echo received by the second audio receiver 120B, and controls the first audio player 110A and the second audio player 110B to play a compensated left channel audio and a compensated right channel audio respectively. Compensating the left channel audio by the first echo refers to generating a first antiphase signal with the same amplitude as the first echo and the inverse phase to the first echo according to the first echo and generating the mutual interference of the first echo and the first antiphase signal according to the principle of interference of sound wave, so as to achieve the offset of the first echo. Likewise, compensating the right channel audio by the second echo refers to generating a second antiphase signal with the same amplitude as the second echo and the inverse phase to the second echo according to the second echo and generating the mutual interference of the second echo and the second antiphase signal according to the principle of interference of sound wave, so as to achieve the offset of the second echo.

It should be noted that the echo belongs to a natural phenomenon, and the echo of the audio signal is generated inevitably and in real time during the playing of the audio signal. The audio playing means provided by the present invention is not intended to eliminate the echoes (including the first echo and the second echo), but compensates the left channel audio played by the first audio player 110A and the right channel audio played by the second audio player 110B through generating the antiphase signals of the echoes so that the compensated left channel audio and the compensated right channel audio are able to offset the first echo and the second echo respectively. Thus the hearing sense of the listener isn't affected by the first echo and the second echo. The echoes are generated in real time according to the audio signals played by the audio players (including the first audio player 110A and the second audio player 110B), and therefore, the antiphase signals not only do not offset the echoes but also are other sources of noise if the processing capacity and the processing speed is not enough.

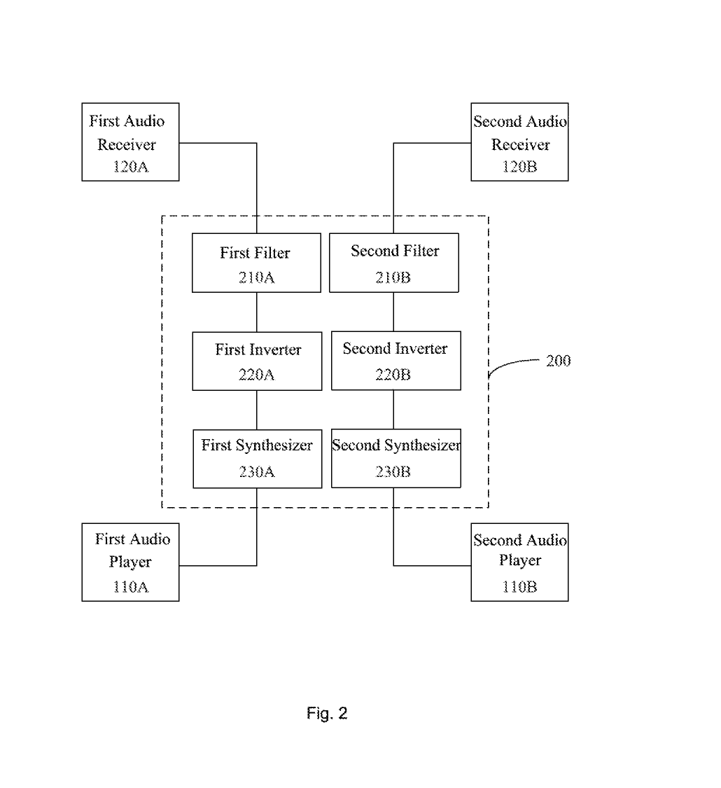

Following is the description of the audio playing means in combination with FIG. 2 according to one embodiment of the present invention. Herein, only the control means 200 comprised in the audio playing means will be mainly described in detail.

Usually, the first audio receiver 120A and the second audio receiver 120B receive all kinds of sound signals in environment, comprising the audio signals played by the first audio player 110A and the second audio player 110B, the echo signals of these audio signals and the background sound signals, etc. The control unit needs to select the first echo of the left channel audio played by the first audio player 110A and the second echo of the right channel audio played by the second audio player 110B from all kinds of the sound signals. Therefore, preferably, the control unit 200 may comprise a first filter 210A and a second filter 210B. The first filter 210A takes the audio signal with the same frequency as the left channel audio and the smaller amplitude than the left channel audio as the first echo. The second filter 210B takes the audio signal with the same frequency as the right channel audio and the smaller amplitude than the right channel audio as the second echo. Alternatively, the control unit 200 may adopt other means to select the first echo and the second echo from all kinds of the sound signals. The preferred embodiment is able to select the echo signals of the left channel audio and the right channel audio quickly and effectively by utilizing the relation between the echo signals and the original sound signals through the first filter 210A and the second filter 210B.

As an example, the control unit 200 comprises a first inverter 220A and a first synthesizer 230A. The first inverter 220A receives the first echo and generates the first antiphase signal with the same frequency as the first echo and the inverse phase to the first echo. The first inverter 220A sends the first antiphase signal to the first synthesizer 230A. The first synthesizer 230A synthesizes the first antiphase signal and the left channel audio to generate the compensated left channel audio. Likewise, the control unit 200 comprises a second inverter 220B and a second synthesizer 230B. The second inverter 220B receives the second echo and generates the second antiphase signal with the same frequency as the second echo and the inverse phase to the second echo. The second inverter 220B sends the second antiphase signal to the second synthesizer 230B. The second synthesizer 230B synthesizes the second antiphase signal and the right channel audio to generate the compensated right channel audio. The present invention is not limited to the embodiments mentioned above. The control unit 200 can comprise other means to obtain the first antiphase signal and the second antiphase signal.

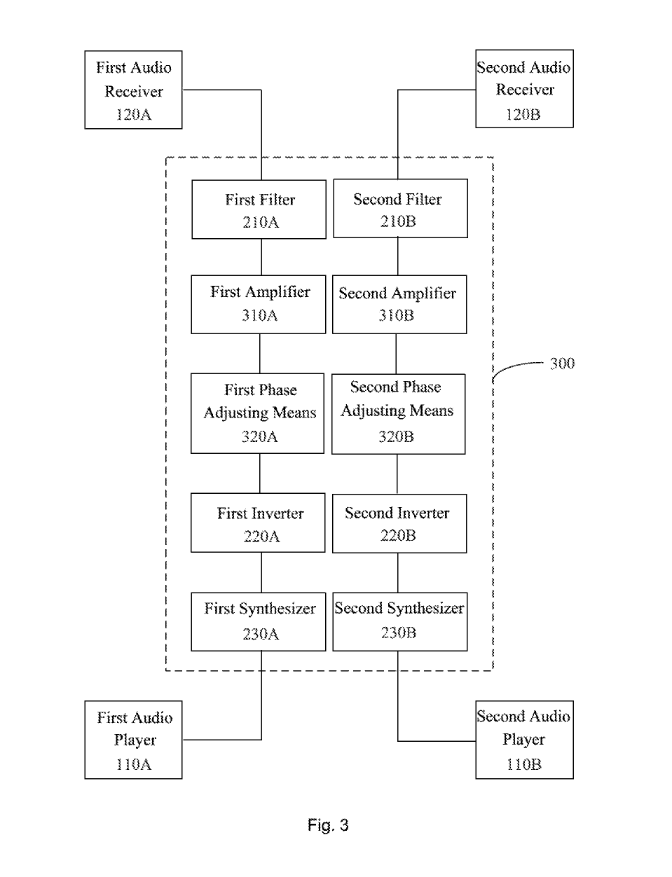

FIG. 3 shows an audio playing means according to a preferred embodiment of the present invention. As shown in FIG. 3, the control unit 300 further comprises a first amplifier 310A and a second amplifier 310B. The first amplifier 310A and the second amplifier 310B are located ahead of the first inverter 220A and the second inverter 220B respectively. The first amplifier 310A and the second amplifier 310B is used for amplifying the first echo and the second echo before the first echo and the second echo are received by the first inverter 220A and the second inverter 220B respectively, so as to conveniently execute all kinds of subsequent calculations to the first echo and the second echo. As for the same components comprised in this preferred embodiment as the embodiment mentioned above, it is no longer described in detail because of their same or similar functions.

After the steps of reflecting, receiving, selecting and amplifying etc., the phases of the left channel audio and the right channel audio are significantly different from those of the original audio signals. The phases of the echo signals and the corresponding audio signals is preferable to be matched before the signals enter the inverter 220A and the inverter 220B, so that the compensated audio signals, which are obtained by synthesizing the antiphase signals (including the first antiphase signal and the second antiphase signal) of the echo signals with the corresponding audio signals, can offset the echo signals effectively. Preferably, the control unit 200 further comprises a first phase adjusting means 320A and a second phase adjusting means 320B. The first phase adjusting means 320A and the second phase adjusting means 320B are behind the first amplifier 310A and the second amplifier 310B respectively in the transfer route of signal, for adjusting the phases of the first echo output by the first amplifier 310A and the second echo output by the second amplifier 310B.

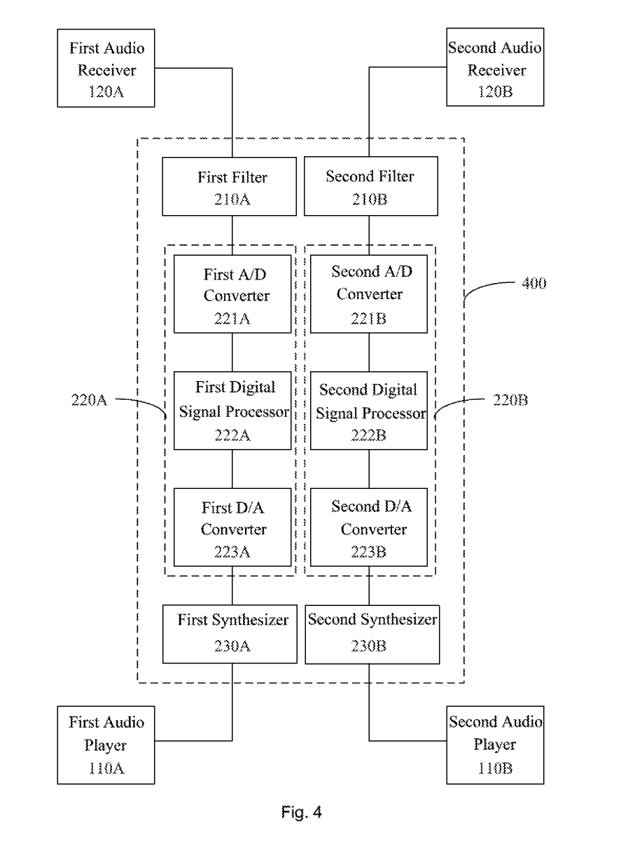

FIG. 4 shows an audio playing means according to yet another preferred embodiment of the present invention. As shown in FIG. 4, the first inverter 220A comprises a first A/D converter a first digital signal processor 222A and a first D/A converter 223A. The first A/D converter 221A converts the first echo received by the first inverter 220A into a digital signal, and sends it to the first digital signal processor 222A. The first digital signal processor 222A generates an antiphase signal of the first echo converted into the digital signal and send it to the first D/A converter 223A. The first D/A converter 223A converts the antiphase signal in the form of the digital signal into an analogue signal to generate the first antiphase signal. The processing capacity and processing speed of the control unit 400 can be improved by converting the analogue signal into the digital signal and performing the antiphase-calculation. As mentioned above, this is very important to the offset of the echoes.

Preferably, as shown in FIG. 4, the second inverter 220B comprises a second A/D converter 221B, a second digital signal processor 222B and a second D/A converter 223B. The second A/D converter 221B converts the second echo received by the second inverter 220B into a digital signal and sends it to the second digital signal processor 222B. The second digital signal processor 222B generates an antiphase signal of the second echo converted into the digital signal and sends it to the second D/A converter 223B. The second D/A converter 223B converts the antiphase signal in the form of the digital signal into an analog signal to generate the second antiphase signal. The processing capacity and processing speed of the control unit 400 can be improved by converting the analogue signal into the digital signal and performing the antiphase-calculation. As mentioned above, this is very important to the offset of the echoes.

The first inverter 220A and the second inverter 220B can have the same structure or different structures, as long as it suffices to fulfill the functions of the two and ensure that the control unit 200 has enough processing capacity and processing speed.

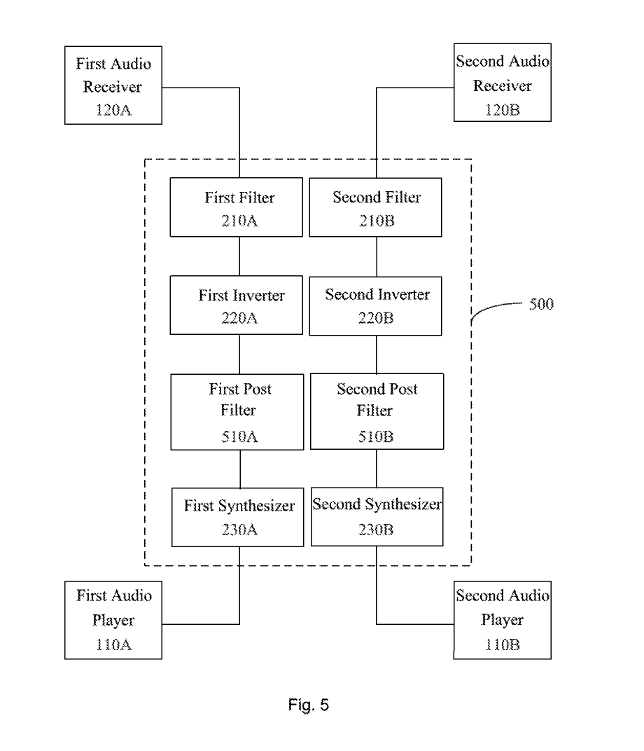

FIG. 5 shows an audio playing means according to the still another preferred embodiment. As shown in FIG. 5, the control unit 400 further comprises a first post filter 510A and a second post filter 510B. The first post filter 510A is disposed between the first inverter 220A and the first synthesizer 230A for smoothing the first antiphase signal output by the first inverter 220A and sending it to the first synthesizer 230A. The second post filter 510B is disposed between the second inverter 220B and the second synthesizer 230B for smoothing the second antiphase signal output by the second inverter 220B and sending it to the second synthesizer 230B. The smoothed antiphase signals are sent to the synthesizers (including the first synthesizer 230A and the second synthesizer 230B) so that the compensated audio signals synthesized by the synthesizers are able to offset the echoes effectively and the stereo effect is improved.

As mentioned above, the background noise would be received by the first audio receiver 120A and the second audio receiver 120B. Usually, the background noise has a fix frequency. Preferably, the control unit 200 can further compensate the left channel audio and the right channel audio according to the noise. The method for compensating the noise by the control unit 200 may be the same as the method for compensating the echoes mentioned above. The method may comprises generating a noise antiphase signal with the same frequency as the fix frequency noise and the inverse phase to the fix frequency noise, and synthesizing this noise antiphase signal with the left channel audio played by the first audio player 110A and the right channel audio played by the second audio player 110B to generate a left channel audio and a right channel audio which are able to compensate the fix frequency noise. In this way, the stereo effect is improved. The means for obtaining the antiphase signal of the noise and the means for synthesizing the audio signal for compensating noise can be the same as the means for compensating the echoes mentioned above. Moreover, the two can be integrated together or exist independently from each another.

According to another aspect of the present invention, a mobile electronic device is further provided. Referring to FIG. 1, the mobile electronic device 100 comprises any kind of the audio playing means mentioned above. The audio playing means comprises a first audio player 110A and a second audio player 110B disposed at the mobile electronic device symmetrically, a first audio receiver 120A and a second audio receiver 120B disposed at the mobile electronic device symmetrically and a control unit (not shown). Each component contained in the audio playing means may refer to the above description. It is no longer described in details herein.

The audio playing means provided by the present invention compensates the left channel audio and the right channel audio by receiving the echoes generated by the left channel audio and the right channel audio to generate the compensated signals which are able to offset the echoes. Therefore, the asymmetry between the left channel audio and the right channel audio is eliminated so that the listener experiences the good stereo effect.

The present invention has been described by the above-mentioned embodiments. However, it will be understood that the above-mentioned embodiments are for the purpose of demonstration and description and not for the purpose of limiting the present to the scope of the described embodiments. Moreover, those skilled in the art could appreciated that the present invention is not limited to the above mentioned embodiments and that various modifications and adaptations in accordance of the teaching of the present invention may be made within the scope and spirit of the present invention. The protection scope of the present invention is further defined by the following claims and equivalent scope thereof.

What is claimed is:

1. An audio playing subsystem of a mobile electronic device, comprising:
a first audio player and a second audio player for playing a left channel audio and a right channel audio respectively;
a first audio receiver and a second audio receiver for receiving a first echo of the left channel audio and a second echo of the right channel audio in real time respectively; and
a control unit for compensating the left channel audio and the right channel audio according to the first echo and the second echo which are received, and controlling the first audio player and the second audio player to play a compensated left channel audio and a compensated right channel audio respectively, wherein the compensated left channel audio and the compensated right channel audio are able to offset the first echo and the second echo respectively.

2. The audio playing subsystem according to claim 1, wherein the control unit comprises a first filter and a second filter, the first filter takes an audio signal with the same frequency as the left channel audio and a smaller amplitude than the left channel audio as the first echo, the second filter takes an audio signal with the same frequency as the right channel audio and a smaller amplitude than the right channel audio as the second echo.

3. The audio playing subsystem according to claim 1, wherein the control unit comprises a first inverter, a first synthesizer, a second inverter and a second synthesizer, the first inverter receives the first echo and generates a first antiphase signal of the first echo, the first synthesizer synthesizes the first anti phase signal and the left channel audio into the compensated left channel audio, the second inverter receives the second echo and generates a second antiphase signal of the second echo, and the second synthesizer synthesizes the second antiphase signal and the right channel audio into the compensated right channel audio.

4. The audio playing subsystem according to claim 3, wherein the control unit further comprises an amplifier for amplifying the first echo and the second echo before the first echo and the second echo are received by the first inverter and the second inverter.

5. The audio playing subsystem according to claim 4, wherein the control unit further comprises a phase adjusting means for adjusting phases of the first echo and the second echo output by the amplifier.

6. The audio playing subsystem according to claim 3, wherein the first inverter comprises a first A/D converter, a first digital signal processor and a first D/A converter, the first A/D converter is used for converting the first echo into a digital signal, the first digital signal processor is used for generating an antiphase signal of the first echo converted into the digital signal, and the first D/A converter is used for converting the antiphase signal in the form of the digital signal into an analogue signal to generate the first antiphase signal.

7. The audio playing subsystem according to claim 3, wherein the second inverter comprises a second A/D converter, a second digital signal processor and a second D/A converter, the second A/D converter is used for converting the second echo into a digital signal, the second digital signal processor is used for generating an antiphase signal of the second echo converted into the digital signal, and the second D/A converter is used for converting the antiphase signal in the form of the digital signal into an analog signal to generate the second antiphase signal.

8. The audio playing subsystem according to claim 3, wherein the control unit further comprises a first post filter and a second post filter, the first post filter is used for smoothing the first antiphase signal output by the first inverter and sending it to the first synthesizer, and the second post filter is used for smoothing the second antiphase signal output by the second inverter and sending it to the second synthesizer.

9. The audio playing subsystem according to claim 1, wherein the first audio receiver and the second audio receiver also receive a noise with a fixed frequency, and the control unit compensates the left channel audio and the right channel audio according to the noise.

10. The audio playing subsystem according to claim 1, wherein the first audio receiver and the second audio receiver are microphones.

11. A mobile electronic device, comprising an audio playing subsystem, the audio playing subsystem including:
a first audio player and a second audio player disposed at the mobile electronic device symmetrically for playing a left channel audio and a right channel audio respectively;
a first audio receiver and a second audio receiver disposed at the mobile electronic device symmetrically for receiving a first echo of the left channel audio and a second echo of the right channel audio in real time respectively; and
a control unit for compensating the left channel audio and the right channel audio according to the first echo and the second echo which are received, and controlling the first audio player and the second audio player to play a compensated left channel audio and a compensated right channel audio respectively, wherein the compensated left channel audio and the compensated right channel audio are able to offset the first echo and the second echo respectively.

12. The mobile electronic device according to claim 11, wherein the control unit comprises a first filter and a second filter, the first filter takes an audio signal with the same frequency as the left channel audio and a smaller amplitude than the left channel audio as the first echo, and the second filter takes an audio signal with the same frequency as the right channel audio and a smaller amplitude than the right channel audio as the second echo.

13. The mobile electronic device according to claim 11, wherein the control unit comprises a first inverter, a first synthesizer, a second inverter and a second synthesizer, the first inverter receives the first echo and generates a first antiphase signal of the first echo, the first synthesizer synthesizes the first antiphase signal and the left channel audio into the compensated left channel audio, the second inverter receives the second echo and generates a second antiphase signal of the second echo, and the second synthesizer synthesizes the second antiphase signal and the right channel audio into the compensated right channel audio.

14. The mobile electronic device according to claim 13, wherein the control unit further comprises an amplifier for amplifying the first echo and the second echo before the first echo and the second echo are received by the first inverter and the second inverter.

15. The mobile electronic device according to claim 14, wherein the control unit further comprises a phase adjusting means for adjusting phases of the first echo and the second echo output by the amplifier.

16. The mobile electronic device according to claim 13, wherein the first inverter comprises a first A/D converter, a first digital signal processor and a first D/A converter, the first A/D converter is used for converting the first echo into a digital signal, the first digital signal processor is used for generating an antiphase signal of the first echo converted into the digital signal, and the first D/A converter is used for converting the antiphase signal in the form of the digital signal into an antilog signal to generate the first antiphase signal.

17. The mobile electronic device according to claim 13, wherein the second inverter comprises a second A/D converter, a second digital signal processor and a second D/A converter, the second A/D converter is used for converting the second echo into a digital signal, the second digital signal processor is used for generating an antiphase signal of the second echo converted into the digital signal, and the second D/A converter is used for converting the antiphase signal in the form of the digital signal into an analog signal to generate the second antiphase signal.

18. The mobile electronic device according to claim 13, wherein the control unit further comprises a first post filter and a second post filter, the first post filter is used for smoothing the first antiphase signal output by the first inverter and sending it to the first synthesizer, and the second post filter is used for smoothing the second antiphase signal output by the second inverter and sending it to the second synthesizer.

19. The mobile electronic device according to claim 11, wherein the first audio receiver and the second audio receiver further receive a noise with a fixed frequency, and the control unit compensates the left channel audio and the right channel audio according to the noise.

20. The mobile electronic device according to claim 11, wherein the first audio player and the second audio player are disposed symmetrically at a top and a bottom of the mobile electronic device respectively, and the first audio receiver and the second audio receiver are disposed symmetrically at the top and the bottom of the mobile electronic device.
